(19) United States
(12) Patent Application Publication
(10) Pub. No.: US 2026/0302647 A1
(43) Pub. Date: Oct. 1, 2026

(54) ANTENNA DEVICE AND VEHICLE-MOUNTED ANTENNA DEVICE

(71) Applicant: AUO Corporation, Hsinchu City (TW)

(72) Inventors: Fu-Yang CHEN, Hsinchu City (TW); Shuo-Yang Sun, Hsinchu City (TW); Chun Chang, Hsinchu City (TW); Hao-Lun Hsieh, Hsinchu City (TW); Jhih-Jhu Jhan, Hsinchu City (TW); Xiao-Yun Li, Hsinchu City (TW); Yu-Hao Chang, Hsinchu City (TW)

(21) Appl. No.: 19/363,193

(22) Filed: Oct. 20, 2025

(30) Foreign Application Priority Data
Mar. 31, 2025 (TW) 114112346

(51) Int. Cl. H01Q 21/06; H01Q 1/32

(52) U.S. Cl. CPC H01Q 21/065; H01Q 1/32

(57) ABSTRACT

An antenna device and a vehicle-mounted antenna device are provided. The antenna device includes a substrate, a support wall, an antenna unit, and a metal plate. The support wall is connected to the substrate and extends from the substrate in a direction away from the substrate. The substrate and the support wall define a space. The antenna unit is located in the space and disposed on the substrate. The metal plate is located in the space and disposed on the support wall. The metal plate is separated from the antenna unit.

This application claims priority to Taiwan Application Serial Number 114112346, filed Mar. 31, 2025. The above-mentioned patent application is herein incorporated by reference in its entirety.

### BACKGROUND

### Technical Field

The present disclosure relates to an antenna device and a vehicle-mounted antenna device.

### Description of Related Art

Antennas have been widely used in vehicle bodies, for example, for navigation, autonomous driving, vehicle tracking, communications, or interconnection with devices inside and outside vehicle bodies. Currently, antennas integrated with vehicle windows have been developed, which not only enhance the appearance of vehicle bodies, but also reduce shielding effects of metal vehicle bodies and improve stability of signals since vehicle windows are made of highly light-transmissive materials. Therefore, antennas integrated with vehicle windows can also support high-band millimeter-wave or low-orbit satellite communications.

However, antennas embedded in vehicle windows still face an issue of electromagnetic waves prone to scattering, resulting in excessive electromagnetic wave loss.

### SUMMARY

At least one embodiment of the present disclosure provides an antenna device and a vehicle-mounted antenna device using the same.

The antenna device provided in the at least one embodiment of the present disclosure comprises a first substrate, a first support wall, a first antenna unit and a first metal plate. The first support wall is connected to the first substrate and extends from the first substrate in a direction away from the first substrate. The first substrate and the first support wall define a first space. The first antenna unit is located in the first space and disposed on the first substrate. The first metal plate is located in the first space and disposed on the first support wall. The first metal plate is separated from the first antenna unit.

In the at least one embodiment of the present disclosure, the first support wall has an inner wall surface surrounding the first antenna unit, and the first metal plate is disposed on the inner wall surface and surrounds the first antenna unit.

In the at least one embodiment of the present disclosure, the first space has a shape of a cylinder, a prism, or a truncated cone.

In the at least one embodiment of the present disclosure, the antenna device further comprises a second substrate and a second antenna unit. The second substrate has a first surface and a second surface opposite to each other. The second substrate is connected to a side of the first support wall opposite to the first substrate and covers the first space. The first surface faces the first space. The second antenna unit is disposed on the second surface of the second substrate. An orthogonal projection of the second antenna unit on the first substrate overlaps at least in part with an orthogonal projection of the first antenna unit on the first substrate, and a width of the first space is greater than that of the second antenna unit.

In the at least one embodiment of the present disclosure, the first metal plate extends to the first surface.

In the at least one embodiment of the present disclosure, the antenna device further comprises a second support wall, a third antenna unit and a second metal plate. The second support wall is connected to the first substrate and extends from the first substrate in a direction away from the first substrate. The second support wall is connected to the first support wall, and the first substrate and the second support wall define a second space. The third antenna unit is located in the second space and disposed on the first substrate. The first antenna unit and the third antenna unit are separated by the first support wall and the second support wall. The second metal plate is located in the second space and disposed on the second support wall. The second metal plate is separated from the third antenna unit.

In the at least one embodiment of the present disclosure, the width of the first space is less than widths of the first antenna unit and the third antenna unit. A width of the second space is less than the widths of the first antenna unit and the third antenna unit.

In the at least one embodiment of the present disclosure, a wall thickness of each of the first support wall and the second support wall ranges from 1 mm to 2 mm.

In the at least one embodiment of the present disclosure, the first metal plate protrudes from an upper surface and a lower surface of the first support wall.

In the at least one embodiment of the present disclosure, a thickness of the first metal plate ranges from 5 microns to 36 microns.

The vehicle-mounted antenna device provided in the at least one embodiment of the present disclosure includes the above antenna device. The antenna device is integrated with a vehicle window of a vehicle body.

Based on the above, the antenna device and the vehicle-mounted antenna device disclosed in the above embodiment, the metal plate located in the same space as the antenna unit can reduce scattering of electromagnetic waves generated by the antenna unit, thereby lowering electromagnetic wave loss.

### BRIEF DESCRIPTION OF THE DRAWINGS

For a more complete understanding of embodiments and their advantages, reference is now made to the following description taken in conjunction with the drawings, in which:

FIG. 1 is a schematic top view of an antenna device integrated with a vehicle window according to at least one embodiment of the present disclosure;

FIG. 2 is a cross-sectional view along cutting line AA' in FIG. 1;

FIGS. 3A and 3B are respectively a partial cross-sectional view and a top view of the antenna device of FIG. 1;

FIGS. 4A and 4B are respectively a partial cross-sectional view and a top view of a further antenna device;

FIG. 5 is a partial cross-sectional view of an antenna device according to a further embodiment of the present disclosure;

FIGS. 6A to 6F are partial cross-sectional views of a portion of a manufacturing method for the antenna device of FIG. 2; and

FIGS. 7A to 7F are partial cross-sectional views of a portion of a manufacturing method for the antenna device of FIG. 5.

### DETAILED DESCRIPTION

For clearly introducing the technical features of the present application below, the dimensions (such as length, width, thickness, and depth) of components (such as layers, membranes, substrates, and areas) in the figures will be scaled up disproportionately, and the number of some components will be reduced. Accordingly, the description and interpretation of the embodiments below shall not be limited to the number of components and the dimensions and shapes of the components shown in the figures, but shall encompass dimensions, shapes and deviations therebetween as a result of actual manufacturing processes and/or tolerances. For example, a flat surface shown in a figure may have a feature of roughness and/or nonlinearity, while an acute angle shown in a figure may be circular. Therefore, the components shown in the figures of the present application are mainly used for schematic purposes, and are not intended to accurately depict the actual shapes of the components, nor are they used to limit the claims of the patent application.

Secondly, the words “about”, “approximately” or “substantially” appearing herein encompass not only clearly recorded values and ranges of values, but also allowable deviation ranges understood by persons of ordinary skill in the art, in which the deviation ranges may be determined by errors resulting from measurements, and the errors are due, for example, to limitations of both a measuring system and process conditions. For example, two objects (such as a plane or a trace of a substrate) are “substantially parallel” or “substantially vertical”, where “substantially parallel” and “substantially vertical” respectively represent that the parallelism and perpendicularity between the two objects may contain non-parallelism and non-perpendicularity caused by the allowable deviation ranges.

In addition, the word “about” can mean within one or more standard deviations of the above values, such as ± 30%, ± 20%, ± 10% or ± 5%. The terms “about”, “approximately” or “substantially” and the like used in the present application may be used to select acceptable deviation ranges or standard deviations based on optical, etchable, mechanical or other properties, rather than a single standard deviation to apply all of the above optical, etchable, mechanical or other properties.

Spatially relative terms used in the present disclosure, such as “under”, “below”, “above”, “over”, are used to facilitate the description of a relative relationship between one component or feature and another component or feature, as shown in the figures. The real meaning of the spatially relative terms involves other orientations. For example, when turning upside down and downside up at 180 degrees, the relationship between one component and another may change from “under” and “below” to “above” and “over”. In addition, spatially relative statements used in the present disclosure shall be similarly interpreted.

In addition, the present disclosure may be implemented or applied by means of other different specific embodiments, the details of the present disclosure may be based on different viewpoints and applications, and various embodiments can be combined, modified and changed without deviating from the idea of the present disclosure. To clearly describe the following embodiments, components with the same or similar functions are denoted by the same reference numerals.

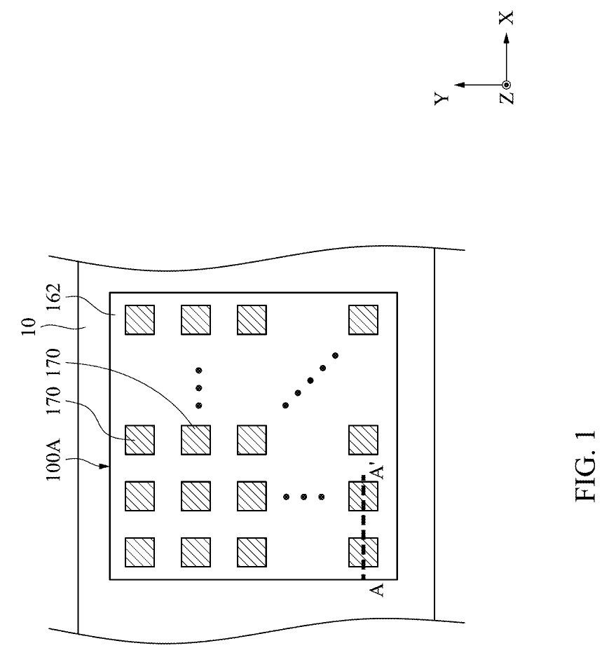

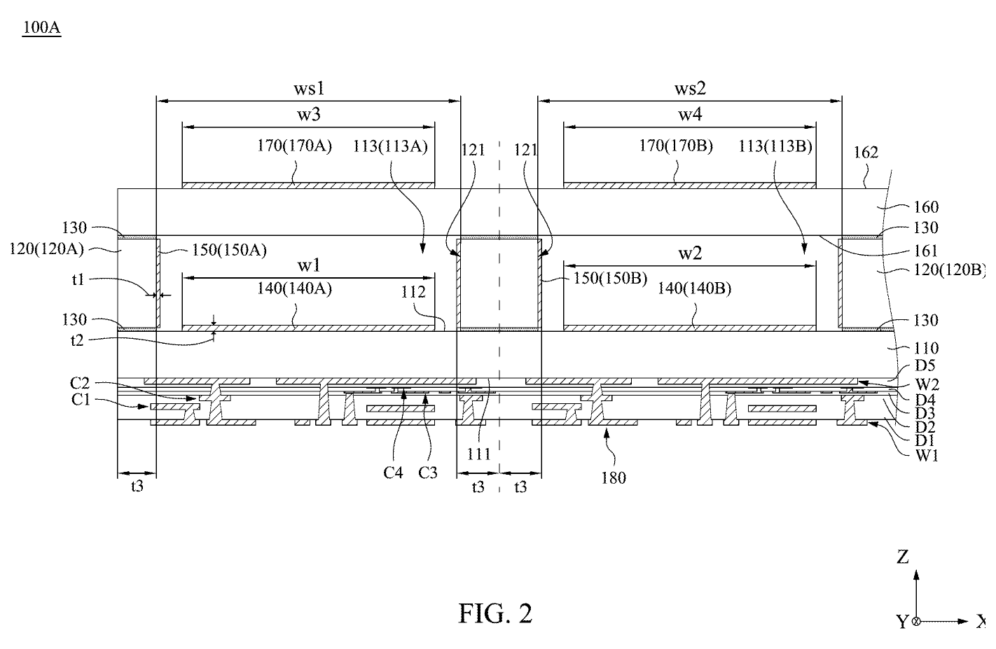

FIG. 1 is a schematic top view of an antenna device 100A integrated with a vehicle window 10 according to at least one embodiment of the present disclosure. FIG. 2 is a cross-sectional view along cutting line AA' in FIG. 1. Referring to FIGS. 1 and 2, the antenna device 100A can reduce scattering of electromagnetic waves, thereby lowering electromagnetic wave loss. For example, the antenna device 100A may be a vehicle-mounted antenna device, i.e., the antenna device 100A may be integrated with a vehicle body, for example, with a vehicle window 10 of the vehicle body (not shown), but is not limited thereto. In other embodiments, the antenna device 100A may be integrated into a vehicle body or disposed on an outer shell of the vehicle body. In other embodiments, the antenna device 100A may be integrated with a window of a building, or with other suitable structures. The antenna device 100A includes a substrate 110, a plurality of support walls 120, a bonding adhesive 130, a plurality of antenna units 140, a plurality of metal plates 150, a substrate 160, a plurality of antenna units 170, a redistribution layer structure 180, and an electronic component (not shown).

The substrate 110 has a surface 111 and a surface 112 opposite to each other in a direction Z. For examples of FIGS. 1 and 2, the redistribution layer structure 180 is disposed on the surface 111 of the substrate 110, and the plurality of support walls 120 and the plurality of antenna units 140 are disposed on the surface 112 of the substrate 110.

The plurality of antenna units 140 are distributed at intervals on the surface 112. The plurality of antenna units 140 may be arranged along directions X and Y to form an array. For example, the antenna unit 140 may be a metal plate body such as a patch antenna. The shape of the antenna unit 140 may be approximately rectangular, but is not limited thereto. In other embodiments, the antenna unit 140 may also be circular, triangular, or annular in shape, or have other polygonal shapes.

The plurality of support walls 120 may be connected via the bonding adhesive 130 to the surface 112 of the substrate 110, and extend from the substrate 110 in a direction (e.g., direction Z) away from the substrate 110. The bonding adhesive 130 may be a UV-curable adhesive, but is not limited thereto. The substrate 110 and each of the support walls 120 defines a space 113, and one antenna unit 140 is located in the space 113. That is to say, the plurality of antenna units 140 are respectively separated by the support walls 120. Further, each of the support walls 120 may have an inner wall surface 121 surrounding the antenna unit 140.

The plurality of metal plates 150 are respectively disposed on the inner wall surfaces 121 of the plurality of support walls 120 and are separated from the antenna units 140. Thus, the metal plates 150 may surround the antenna units 140, respectively. A thickness t1 of each of the metal plates 150 may be less than or equal to a thickness t2 of each of the antenna units 140. For example, the thickness t1 of each of the metal plates 150 ranges from 5 micrometers to 36 micrometers. The metal plates 150 may almost completely cover the inner wall surfaces 121 of the support walls 120, and are flush with upper surfaces 122 and lower surfaces 123 of the support walls 120, but are not limited thereto. In other embodiments, the metal plates 150 may also protrude from the upper surfaces 122 and the lower surfaces 123 of the support walls 120.

The metal plates 150 may be used to reduce scattering of electromagnetic waves generated by the antenna units 140, thereby lowing electromagnetic wave loss. That is to say, the metal plates 150 are respectively located in the spaces 113, so that the antenna units 140 may enhance antenna efficiency via the metal plates 150. In other words, the spaces 113 may be antenna efficiency enhancement spaces.

It should be noted that for examples of FIGS. 1 and 2, a layer of the support walls 120 is stacked on the substrate 110. In other embodiments, two or more layers of support walls 120 may be stacked on the substrate 110, and the metal plates 150 are also disposed on the second or higher layer of stacked support walls 120 without limitation. Specifically, some support walls 120 are stacked on the substrate 110 to form a first layer of support walls 120, while other support walls 120 are connected to the first layer of support walls 120 via the bonding adhesive 130 to form a second layer of support walls 120. Similarly, some other support walls 120 may be connected to the second layer of support walls 120 via the bonding adhesive 130 to form a third layer of support walls 120.

To clearly illustrate the connection relationships between the plurality of support walls 120, FIG. 2 illustrates two support walls 120 distributed along the direction X, where the left support wall 120 is configured as a support wall 120A, and the right support wall 120 is configured as a support wall 120B. The support walls 120A and 120B are connected to the surface 112 of the substrate 110, and the support wall 120A is connected to the support wall 120B. For example, portions of the support walls 120A and 120B therebetween extending along the direction Y are connected to each other. The support wall 120A defines a space 113A, and the support wall 120B defines a space 113B, where a metal plate 150A is located in the space 113A, and a metal plate 150B is located in the space 113B. Therefore, an antenna unit 140A in the space 113A and an antenna unit 140B in the space 113B are separated from each other via the portions of the support walls 120A and 120B extending along direction Y.

Therefore, the plurality of antenna units 140 distributed along the direction X are separated from each other via the portions of the support walls 120 extending along the direction Y. On the other hand, the plurality of antenna units 140 distributed along the direction Y are separated from each other via the portions of the support walls 120 extending along the direction X.

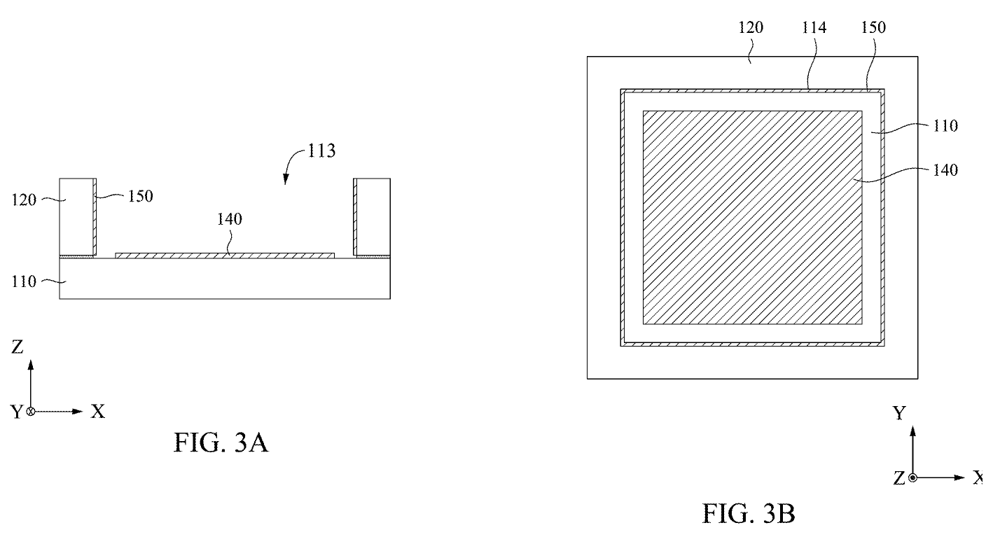

FIGS. 3A and 3B are respectively a partial cross-sectional view and a top view of the antenna device 100A of FIG. 1, where FIGS. 3A and 3B illustrate a partial substrate 110, a support wall 120, an antenna unit 140 and a metal plate 150. Referring to FIGS. 1 to 3B, each of the support walls 120 defines the space 113, and the space 113 may have a shape of a cylinder, a prism, or a truncated cone, without limitation. For examples of FIG. 3A and FIG. 3B, the space 113 has a shape of a quadrangular prism such as a cube. As shown in FIG. 3B, the support wall 120 defines an opening 114 in communication with the space 113, and the opening 114 is square in shape.

In detail, in the examples of FIG. 3A and FIG. 3B, in a direction (direction Z) away from the corresponding antenna unit 140, a width of each space 113 remains constant, that is, a wall thickness of each support wall 120 remains constant. Consequentially, each of the metal plates 150 disposed on the support wall 120 can not only improve electromagnetic wave loss, but also enhance directivity of electromagnetic waves radiated by the antenna unit 140.

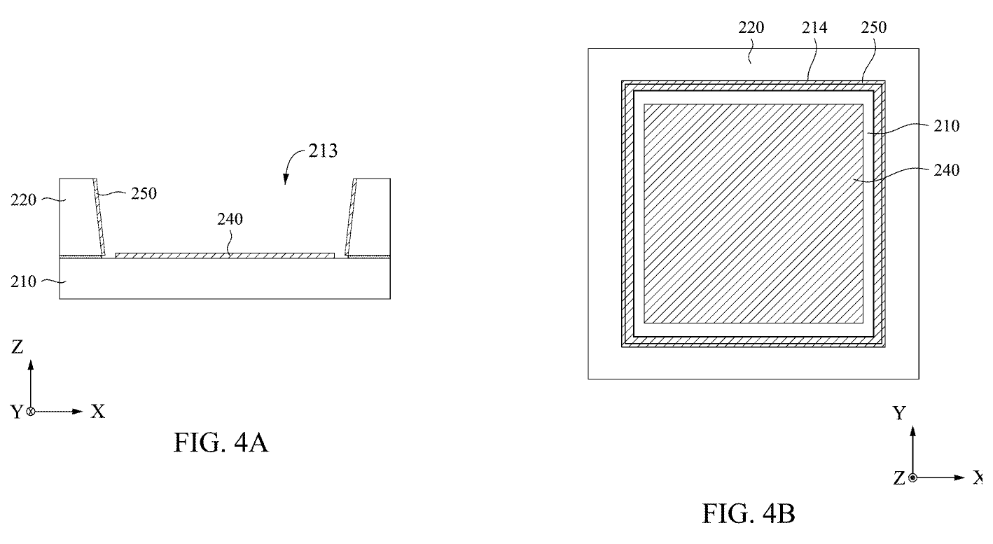

FIGS. 4A and 4B are respectively a partial cross-sectional view and a top view of a further antenna device, where FIGS. 4A and 4B also illustrate a partial substrate 210, a support wall 220, an antenna unit 240 and a metal plate 250. Referring to FIG. 4A and FIG. 4B, the support wall 220 is connected to the substrate 210, and extends from the substrate 210 in a direction (e.g., direction Z) away from the substrate 210. The substrate 210 and the support wall 220 defines a space 213, and the antenna unit 240 is located in the space 213 and disposed on the substrate 210. In particular, the space 213 has a shape of a truncated cone such as a quadrangular truncated cone. The support wall 220 defines an opening 214 in communication with the space 213, and the opening 214 is also square in shape.

In detail, in examples of FIG. 4A and FIG. 4B, in a direction (direction Z) away from the corresponding antenna unit 240, a width of the space 213 gradually increases, that is, a wall thickness of each support wall 220 gradually decreases. Consequentially, each metal plate 250 disposed on the support wall 220 can not only improve electromagnetic wave loss, but also enhance a radiation angle of the corresponding antenna unit 240. Therefore, in the directions (direction Z) away from the corresponding antenna units 140, 240, the width of each of the spaces 113 and 213 can be changed according to the application environment of the antenna device 100A. That is, the structure of each of the support walls 120, 220 is changed so that the widths of the spaces 113, 213 can remain fixed, increase gradually, or decrease gradually, without limitation.

Referring to FIGS. 1 and 2, the substrate 160 has a surface 161 and a surface 162 that are opposite to each other in the direction Z. The substrate 160 may also be connected via the bonding adhesive 130 to one sides of the plurality of support walls 120 opposite to the substrate 110 and cover the plurality of spaces 113, where the surface 161 may face the plurality of spaces 113. In other words, the substrates 110 and 160 are located on opposite two sides of each of the support walls 120, and the plurality of support walls 120 are located between the substrates 110 and 160. In addition, a thickness t3 of each of the support walls 120 may range from 1 mm to 2 mm, so that the plurality of support walls 120 have sufficient supports between the substrates 110 and 160.

For example, the antenna device 100A may be integrated with the vehicle window 10 of the vehicle body via at least one of the substrate 110, the support walls 120, and the substrate 160. For examples of FIGS. 1 and 2, the substrate 110, the support walls 120, and the substrate 160 of the antenna device 100A are all integrated with the vehicle window 10 of the vehicle body. When the antenna device 100A is integrated with the vehicle window 10 (e.g., a sunroof), the surface 111 may face the interior of the vehicle (under the vehicle), while the surface 112 and the surface 161 face each other, and the surface 162 may face the exterior of the vehicle body (above the vehicle body).

The plurality of antenna units 170 are distributed at intervals on the surface 162. The structure of each of the antenna units 170 may be similar to the structure of each of the antenna units 140. The antenna unit 170 may also be a metal plate body, such as a patch antenna. Orthogonal projections of the plurality of antenna units 170 on the substrate 110 overlap at least in part with orthogonal projections of the plurality of antenna units 140 on the substrate 110, respectively. For example, the projections of the plurality of antenna units 170 in the direction Z (projections on the substrate 110) overlap at least in part with the projections of the plurality of antenna units 140 in the direction Z (projections on the substrate 110), respectively. For example of FIG. 2, the antenna unit 170A overlaps fully with the antenna unit 140A, and the antenna unit 170B overlaps fully with the antenna unit 140B.

It is worth mentioning that the width of each space 113 may be greater than the width of the antenna unit 170. In other words, the orthogonal projection of the antenna unit 170 on the substrate 110 (projection in the direction Z) is within the orthogonal projection of the support wall 120 on the substrate 110 (projection in the direction Z). In addition, in the two adjacent support walls 120, such as the support wall 120A and the support wall 120B, the orthogonal projection of the support wall 120A on the substrate 110 will not overlap with the orthogonal projections of the antenna units 140B and 170B on the substrate 110, and the orthogonal projection of the support wall 120B on the substrate 110 will not overlap with the orthogonal projections of the antenna unit 140A and 170A on the substrate 110.

In other words, a width ws1 of the space 113A is less than a combined width of the antenna units 140A and 140B (the widths w1 and w2 of the antenna units 140A and 140B), and also less than a combined width of the antenna units 170A and 170B (the widths w3 and w4 of the antenna units 170A and 170B). Similarly, a width ws2 of the space 113B is less than the combined width of the antenna units 140A and 140B, and also less than the combined width of the antenna units 170A and 170B. In short, only one antenna unit 140 is disposed in each space 113, and the orthogonal projection of each support wall 120 on the substrate 110 only surrounds the orthogonal projections of one antenna unit 140 and one antenna unit 170 on the substrate 110. Since the radiation directions of respective antenna units 140 may be different, only one antenna unit 140 is disposed in each of the spaces 113, which facilitates control of a gain of each antenna unit 140.

It should further be noted that the antenna unit 170 resonates with the antenna unit 140 to increase an operational bandwidth of the antenna device 100A. In other embodiments, the antenna device may not have the substrate 160 and the plurality of antenna units 170. For example, the antenna device 100A may operate in the Ka band (26.5 GHz-40 GHz) and the Ku band (12 GHz-18 GHz) simultaneously. In other embodiments, the antenna device without the plurality of antenna units 170 operates solely in the Ka-band.

The redistribution layer structure 180 may include two outer wiring layer W1 and W2, a plurality of dielectric layers D1, D2, D3, D4, and D5, and a plurality of conductive layers C1, C2, C3, and C4. For example, along the direction Z, the outer wiring layer W1, the dielectric layer D1, the conductive layer C1, the dielectric layer D2, the conductive layer C2, the dielectric layer D3, the conductive layer C3, the dielectric layer D4, the conductive layer C4, the dielectric layer D5 and the outer wiring layer W2 can be stacked in sequence, where the outer wiring layer W1 includes a plurality of pads, and the outer wiring layer W2 includes a plurality of pads. The outer wiring layer W2 and part of the dielectric layer D5 are disposed on the surface 111 of the substrate 110. The electronic component (not shown), such as a chip, can be electrically connected to the pads of the outer wiring layer W1.

For examples of FIG. 1 and FIG. 2, the chip (not shown) can provide a feed signal to be transmitted to the redistribution layer structure 180, and energy of the feed signal can be coupled to the antenna units 140 and 170, causing the antenna device 100A to radiate electromagnetic waves. In other embodiments, the feed signal provided by the chip may be directly fed to the antenna unit 140 via a conductive structure penetrating the substrate 110, and then coupled to the antenna unit 170 without limitation.

It should be noted that the materials of the substrates 110, 160 and the support walls 120 may be glass, but are not limited thereto. In other embodiments, the materials of the substrates 110 and 160 and the support walls 120 may be polyvinyl butyral (PVB), polyethylene terephthalate (PET), polycarbonate (PC), or other materials with high hardness and good light transmittance. The material of the metal plate 150 may be gold, silver, copper, aluminum, alloy steel, or other suitable metals or alloys. The material of the metal plate 150 may be selected according to the application environment of the antenna device 100A. For example, metallic gold is not easy to oxidize, metallic silver offers good conductivity, metallic copper provides good thermal conductivity, metallic aluminum is relatively inexpensive, and alloy steel exhibits strong corrosion resistance.

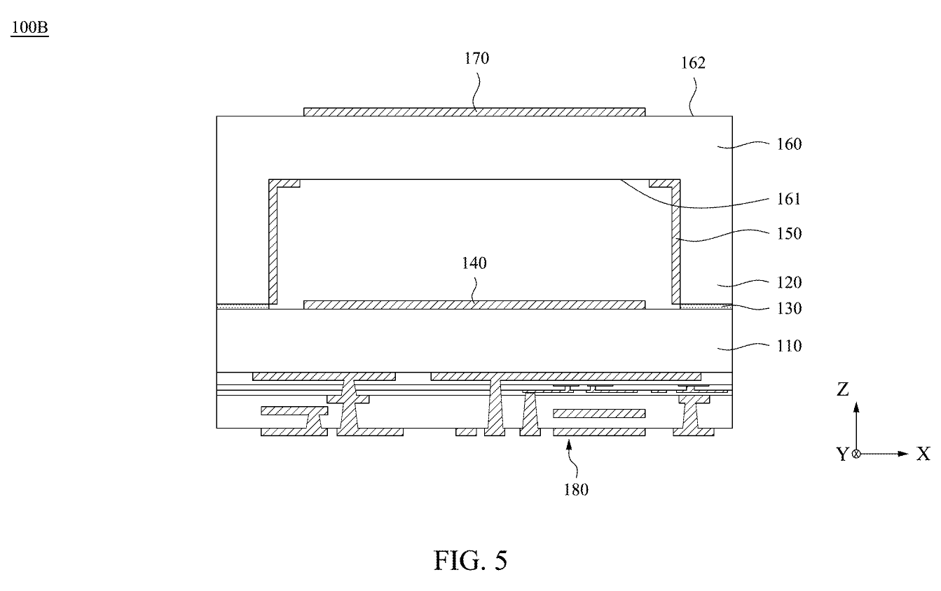

FIG. 5 is a partial cross-sectional view of an antenna device 100B according to a further embodiment of the present disclosure, where FIG. 5 only shows one support wall 120. Referring to FIG. 5, the antenna device 100B of FIG. 5 is similar to the antenna device 100A of FIG. 2. A difference between them is that a metal plate 150 of the antenna device 100B may extends onto a surface 161 of a substrate 160. Additionally, a plurality of support walls 120 may be integrally formed with the substrate 160. Thus, during the manufacturing of the antenna device 100B, no additional connection is required between the support wall 120 and the substrate 160, thereby reducing the number of alignment operations. In the antenna device 100B, each metal plate 150 disposed on the support wall 120 also can reduce scattering of electromagnetic waves to lower electromagnetic wave loss.

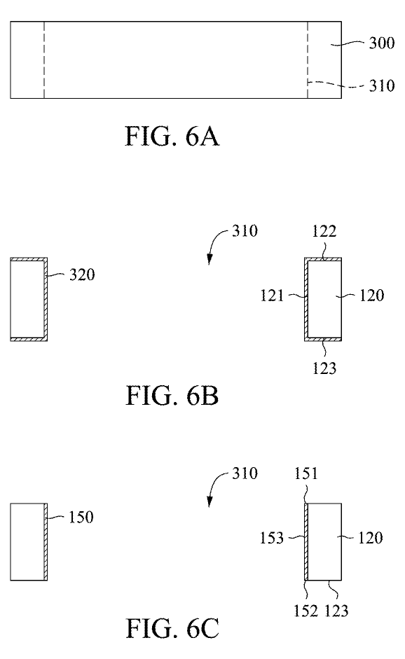

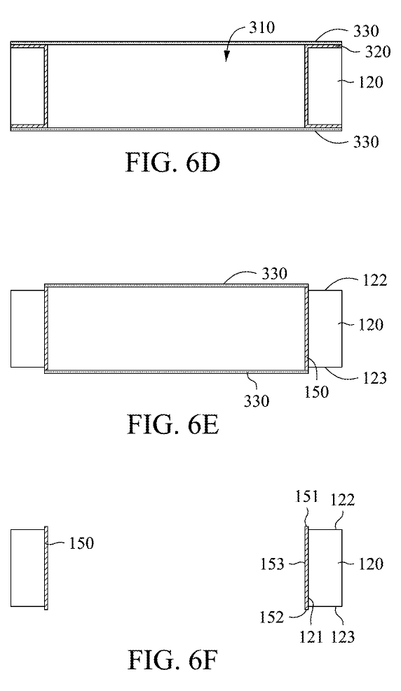

FIGS. 6A to 6F are partial cross-sectional views of a portion of a manufacturing method for the antenna device 100A of FIG. 2, where FIGS. 6A to 6C depict one manufacturing process for disposing each metal plate 150 on a corresponding support wall 120, while FIGS. 6A, 6B, and 6D to 6F, depict another manufacturing process for disposing each metal plate 150 on a corresponding support wall 120. Referring to FIG. 6A, a cavity 310 is formed in a support structure 300, so that the support structure 300 forms the support wall 120, where the cavity 310 may penetrate the support structure 300, and the shape of the cavity 310 is the same as that of the space 113 (FIG. 2). The formation of the cavity 310 in the support structure 300 may be accomplished by laser processing or mechanical processing.

Referring to FIG. 6B, a metal layer 320 is then formed on the inner wall surface 121, the upper surface 122, and the lower surface 123 of the support wall 120. For example, a metal thin film may be first formed on the inner wall surface 121, the upper surface 122 and the lower surface 123 using a chemical plating process or a sputtering process. Thereafter, an electroplating process is used to thicken the metal thin film to form a metal layer 320 having an appropriate thickness. Since the metal thin film is first formed on the support wall 120, the subsequent electroplating process can smoothly thicken the metal thin film.

Referring to FIG. 6C, the metal layer 320 covered on the upper surface 122 and the lower surface 123 of the support wall 120 is then removed to form the metal plate 150. The metal layer 320 may be removed by means of a chemical-mechanical polishing (CMP) process. Further, since the upper surface 122 and the lower surface 123 of the support wall 120 are subjected to chemical-mechanical polishing, the roughness of the upper surface 122 and the lower surface 123 is lower than that of the inner wall surface 121. Furthermore, since the upper surface 151 and the lower surface 152 of the metal plate 150 are subjected to chemical-mechanical polishing, the roughness of an inner wall surface 153 (formed only by the electroplating process) of the metal plate 150 that is not subjected to chemical-mechanical polishing is lower than that of the upper surface 151 and the lower surface 152. In other words, the inner wall surface 153 of the metal plate 150 is smoother than the upper surface 151 and the lower surface 152 thereof.

In other embodiments, after the metal layer 320 (as shown in FIG. 6B ) is formed on the inner wall surface 121, the upper surface 122 and the lower surface 123 of the support wall 120, the metal layer 320 covered on the upper surface 122 and the lower surface 123 of the support wall 120 may be removed using a lithography process and an etching process. Referring to FIG. 6D, first, a dry film photoresist 330 may be disposed on the upper and lower surfaces of the metal layer 320. It is worth mentioning that the advantage of using the dry film photoresist 330 is that the dry film photoresist 330 does not enter the cavity 310 and thus avoids adhering to the inner wall surface of the metal layer 320, thereby maintaining the integrity of the subsequently formed metal plate 150. Referring to FIG. 6E, subsequently, through an exposure process, a development process, and an etching process, the metal layer 320 on the upper surface 122 and the lower surface 123 of the support wall 120 is removed to form the metal plate 150.

Referring to FIGS. 6E and 6F, thereafter, the remaining dry film photoresist 330 is removed. In particular, the metal plate 150 protrudes from the upper surface 122 and the lower surface 123 of the support wall 120. Furthermore, since the upper surface 122 and the lower surface 123 of the support wall 120 are subjected to the etching process, the roughness of the upper surface 122 and the lower surface 123 is lower than that of the inner wall surface 121. Moreover, since the upper surface 151 and the lower surface 152 of the metal plate 150 are not subjected to chemical-mechanical polishing, the roughness of the upper surface 151, the lower surface 152 and the inner wall surface 153 (formed solely by the electroplating process) of the metal plate 150 are similar, maintaining the same smoothness, thereby reducing signal loss.

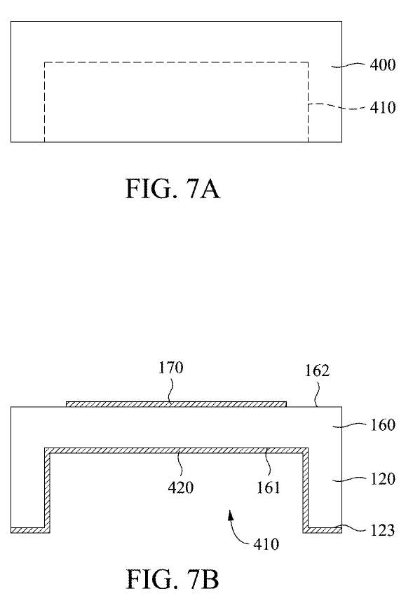

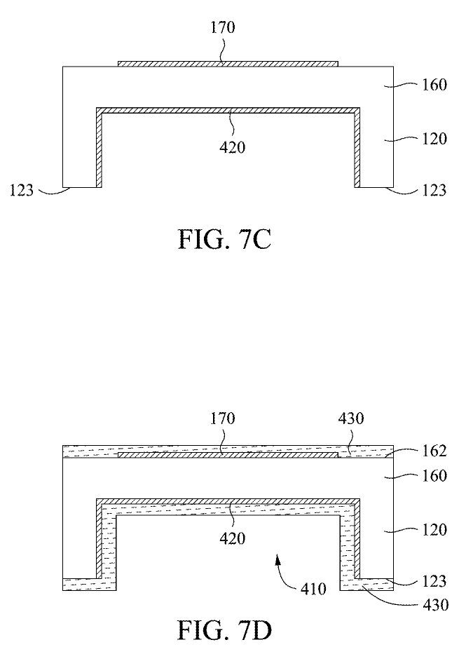

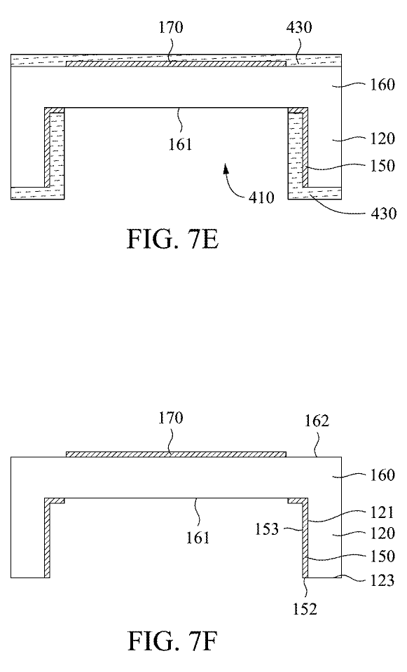

FIGS. 7A to 7F are partial cross-sectional views of a portion of a manufacturing method for the antenna device 100B of FIG. 5, where FIGS. 7A to 7F depict a manufacturing process for disposing each metal plate 150 on the corresponding support wall 120 and disposing an antenna unit 170 on the substrate 160. Referring to FIG. 7A, a groove 410 is formed in a support structure 400, so that the support structure 400 forms the support wall 120 and the substrate 160. The formation of the groove 410 in the support structure 400 may be accomplished by laser processing, machining, or etching processes.

Referring to FIG. 7B, a metal layer 420 is then formed on the surface 161 of the substrate 160 and the lower surface 123 of the support wall 120, and the antenna unit 170 is formed on the surface 162 of the substrate 160. It should be noted that there is no limitation on the order of forming the metal layer 420 and the antenna unit 170. The formation of the metal layer 420 may be accomplished in a manner similar to that shown in FIG. 6B. For example, a metal thin film is first formed on the surface 161 of the substrate 160 and the lower surface 123 of the support wall 120 using the chemical plating process or the sputtering process. Thereafter, the electroplating process is used to thicken the metal thin film to form the metal layer 420 having an appropriate thickness. The formation of the antenna unit 170 may be accomplished using the photolithography process and the etching process.

Referring to FIG. 7C, the metal layer 420 on the lower surface 123 of the support wall 120 is then removed. The removal of the metal layer 420 can be accomplished using the chemical-mechanical polishing process. Referring to FIG. 7D, subsequently, a liquid film photoresist 430 is coated on the antenna unit 170, the surface 162 of the substrate 160, the lower surface 123 of the support wall 120, and the metal layer 420. It is worth mentioning that the advantage of using the liquid film photoresist 430 is that the liquid film photoresist 430 can more easily and completely cover the metal layer 420 in the groove 410. Referring to FIGS. 7D and 7E, subsequently, through the exposure process, the development process, and the etching process, a portion of the metal layer 420 on the surface 161 of the substrate 160 is removed to form the metal plate 150. Referring to FIGS. 7E and 7F, thereafter, the remaining liquid film photoresist 430 is removed. In particular, the metal plate 150 extends onto the surface 161 of the substrate 160.

Furthermore, since the lower surface 123 of the support wall 120 is subjected to the chemical-mechanical polishing and etching processes, the roughness of the lower surface 123 is lower than that of the inner wall surface 121. Moreover, since the lower surface 152 of the metal plate 150 is also subjected to chemical-mechanical polishing, the roughness of the inner wall surface 153 (formed only by the electroplating process) of the metal plate 150 that is not subjected to chemical-mechanical polishing is lower than that of the lower surface 152 of the metal plate 150. In other words, the inner wall surface 153 of the metal plate 150 is smoother than the lower surface 152 thereof. It should be noted that the process of FIG. 7C may also be omitted, and the metal layer 420 on the lower surface 123 of the support wall 120 may be removed directly in the subsequent lithography and etching processes (the processes of FIG. 7D and FIG. 7E) without limitation.

In summary, in the antenna devices disclosed in the above embodiments, the metal plates and the antenna units are disposed within the same spaces to reduce scattering of electromagnetic waves generated by the antenna units, thereby lowering electromagnetic wave loss. Additionally, by changing the structures of the support walls, the width of the spaces may be maintained as fixed, gradually increased, or gradually decreased, which not only lowers electromagnetic wave loss but also enhances the directivity or radiation angle of the electromagnetic waves radiated by the antenna units, thereby broadening the applicability of the antenna device.

Although the present disclosure has been disclosed as above in embodiments, the embodiments are not intended to limit the present disclosure, and those of ordinary skill in the art may make some changes and embellishments within the spirit and scope of the present disclosure, therefore, the scope of protection of the present disclosure shall be defined in the attached claims.

What is claimed is:

1. An antenna device, comprising:
a first substrate;
a first support wall connected to the first substrate and extending from the first substrate in a direction away from the first substrate, wherein the first substrate and the first support wall define a first space;
a first antenna unit located in the first space and disposed on the first substrate; and
a first metal plate located in the first space and disposed on the first support wall, wherein the first metal plate is separated from the first antenna unit.

2. The antenna device according to claim 1, wherein the first support wall has an inner wall surface surrounding the first antenna unit, and the first metal plate is disposed on the inner wall surface and surrounds the first antenna unit.

3. The antenna device according to claim 2, wherein the first space has a shape of a cylinder, a prism, or a truncated cone.

4. The antenna device according to claim 2, further comprising:
a second substrate having a first surface and a second surface opposite to each other, wherein the second substrate is connected to a side of the first support wall opposite to the first substrate and covers the first space, the first surface facing the first space; and
a second antenna unit disposed on the second surface of the second substrate, wherein an orthogonal projection of the second antenna unit on the first substrate overlaps at least in part with an orthogonal projection of the first antenna unit on the first substrate, and a width of the first space is greater than that of the second antenna unit.

5. The antenna device according to claim 4, wherein the first metal plate extends to the first surface.

6. The antenna device according to claim 4, further comprising:
a second support wall connected to the first substrate and extending from the first substrate in a direction away from the first substrate, wherein the second support wall is connected to the first support wall, and the first substrate and the second support wall define a second space;
a third antenna unit located in the second space and disposed on the first substrate, wherein the first antenna unit and the third antenna unit are separated by the first support wall and the second support wall; and
a second metal plate located in the second space and disposed on the second support wall, wherein the second metal plate is separated from the third antenna unit.

7. The antenna device according to claim 6, wherein the width of the first space is less than widths of the first antenna unit and the third antenna unit, and a width of the second space is less than the widths of the first antenna unit and the third antenna unit.

8. The antenna device according to claim 6, wherein a wall thickness of each of the first support wall and the second support wall ranges from 1 mm to 2 mm.

9. The antenna device according to claim 1, wherein the first metal plate protrudes from an upper surface and a lower surface of the first support wall.

10. The antenna device according to claim 1, wherein a thickness of the first metal plate ranges from 5 microns to 36 microns.

11. A vehicle-mounted antenna device, comprising:
an antenna device, comprising:
a first substrate;
a first support wall, connected to the first substrate and extending from the first substrate in a direction away from the first substrate, wherein the first substrate and the first support wall define a first space;
a first antenna unit, located in the first space and disposed on the first substrate; and
a first metal plate, located in the first space and disposed on the first support wall, wherein the first metal plate is separated from the first antenna unit; and
wherein the antenna device is integrated with a vehicle window of a vehicle body.

12. The vehicle-mounted antenna device according to claim 11, wherein the first support wall has an inner wall surface surrounding the first antenna unit, and the first metal plate is disposed on the inner wall surface and surrounds the first antenna unit.

13. The vehicle-mounted antenna device according to claim 12, wherein the first space has a shape of a cylinder, a prism, or a truncated cone.

14. The vehicle-mounted antenna device according to claim 12, further comprising:
a second substrate having a first surface and a second surface opposite to each other, wherein the second substrate is connected to a side of the first support wall opposite to the first substrate and covers the first space, the first surface facing the first space; and
a second antenna unit disposed on the second surface of the second substrate, wherein an orthogonal projection of the second antenna unit on the first substrate overlaps at least in part with an orthogonal projection of the first antenna unit on the first substrate, and a width of the first space is greater than that of the second antenna unit.

15. The vehicle-mounted antenna device according to claim 14, wherein the first metal plate extends to the first surface.

16. The vehicle-mounted antenna device according to claim 14, further comprising:
a second support wall connected to the first substrate and extending from the first substrate in a direction away from the first substrate, wherein the second support wall is connected to the first support wall, and the first substrate and the second support wall define a second space;
a third antenna unit located in the second space and disposed on the first substrate, wherein the first antenna unit and the third antenna unit are separated by the first support wall and the second support wall; and
a second metal plate located in the second space and disposed on the second support wall, wherein the second metal plate is separated from the third antenna unit.

17. The vehicle-mounted antenna device according to claim 16, wherein the width of the first space is less than widths of the first antenna unit and the third antenna unit, and a width of the second space is less than the widths of the first antenna unit and the third antenna unit.

18. The vehicle-mounted antenna device according to claim 16, wherein a wall thickness of each of the first support wall and the second support wall ranges from 1 mm to 2 mm.

19. The vehicle-mounted antenna device according to claim 11, wherein the first metal plate protrudes from an upper surface and a lower surface of the first support wall.

20. The vehicle-mounted antenna device according to claim 11, wherein a thickness of the first metal plate ranges from 5 microns to 36 microns.
